(19) United States
(12) Patent Application Publication
(10) Pub. No.: US 2007/0171586 A1
(43) Pub. Date: Jul. 26, 2007

(54) System and method for operating multiple devices from one electrical source

(75) Inventors: Thomas K. Reusche, Elburn, IL (US); Philip E. Chumbley, Aurora, IL (US)

Correspondence Address: MCANDREWS HELD & MALLOY, LTD, 500 WEST MADISON STREET, SUITE 3400, CHICAGO, IL, 60661, US

(73) Assignee: Allied Precision Industries, Inc.

(21) Appl. No.: 11/653,520

(22) Filed: Jan. 16, 2007

Related U.S. Application Data
(60) Provisional application No. 60/760,719, filed on Jan. 20, 2006.

(51) Int. Cl. H02H 3/00

(52) U.S. Cl. 361/42

(57) ABSTRACT

An apparatus configured to selectively supply power among a plurality of electrical devices, includes a plug configured to be electrically connected to a power source, a first outlet selectively connected to the plug, a first sensor connected to the first outlet, a first switch disposed between the first outlet and the plug, a second outlet selectively connected to the plug, a second sensor connected to the second outlet, a second switch disposed between the second outlet and the plug, and a processing unit in electrical communication with the first and second switches and the first and second sensors. The processing unit being configured to selectively open and close the first and second switches based on parameters sensed by the first and second sensors.

### RELATED APPLICATIONS

This application relates to and claims priority benefits from U.S. Provisional Patent Application No. 60/760,719 entitled “Switching Apparatus for Operating Multiple High-Current Devices From One Electrical Circuit,” filed Jan. 20, 2006, which is hereby incorporated by reference in its entirety

### BACKGROUND OF THE INVENTION

Embodiments of the present invention generally relate to a system and method for operating multiple electrical devices, and more particularly, to a switching system and method for operating multiple high-current devices from a single electrical source.

Various electrical devices draw a current from a power source that is more than half of the allowable capacity for the power source. For example, a 1000 watt heater may draw 8.3 amps, while a 1500 Watt heater may draw 12.5 amps. The maximum current for a standard electrical circuit may only be, however, 15 amps. Thus, the current draw for either of the electrical devices is such that only a single device may be operated at any given time. If multiple devices are to be used, the additional devices typically are plugged into separate sources of electrical power, which may require installation of extra circuits or long extension cords.

Some electrical devices, such as water deicers, are designed to run intermittently. For example, a typical 1500 Watt deicer may be used to keep ice from forming in a 100 gallon livestock tank. The deicer may activate when the water temperature drops below a certain cool temperature, such as 40° F. When the water drops below that temperature, the deicer activates and heats the water to a particular heated temperature, such as 55° F. When the water temperature is heated to the heated temperature, the deicer deactivates. The deicer then remains deactivated until the water temperature dips below the cool temperature again, at which point the cycle is repeated.

The duty cycle for a typical deicer (i.e., the percentage of time that the deicer is activated) is typically less than 50%. Thus, even though a deicer may draw more than half of the allowable current from a power source, the deicer is operating less than half the time. Nevertheless, in order to provide power to separate deicers, each deicer is typically connected to a separate source of electrical power.

Thus, a need exists for a system and method of efficiently delivering electrical power to multiple electrical devices that are intermittently activated.

### SUMMARY OF THE INVENTION

Certain embodiments of the present invention provide an apparatus configured to selectively supply power among a plurality of electrical devices. The apparatus may include a plug configured to be electrically connected to a power source, a first outlet selectively connected to the plug, a first sensor connected to the first outlet, a first switch disposed between the first outlet and the plug, a second outlet selectively connected to the plug, a second sensor connected to the second outlet, a second switch disposed between the second outlet and the plug, and a processing unit in electrical communication with the first and second switches and the first and second sensors. The processing unit is configured to selectively open and close the first and second switches to complete and break first and second circuits based on parameters sensed by the first and second sensors.

The processing unit may be configured to close one of the first and second switches to complete a first circuit or second circuit, respectively, based on whether a device attempts to draw current through one of the first and second outlets. Alternatively, the processing unit may be configured to close one of the switches to complete a circuit based on a sensed change of resistance at one of the outlets.

The processing unit may be configured to close the first switch to complete a first circuit when the processing unit determines that a first device is attempting to draw current through the firs t outlet. The processing unit may simultaneously open the second switch to break a second circuit. The processing unit may also be configured to open the first switch to break the first circuit when the processing unit determines that the first device is no longer attempting to draw current through the first outlet.

The apparatus may also include a thermometer in electrical communication with the processing unit. The processing unit may open both the first and second switches to break the first and second circuits when the thermometer detects a temperature above a predetermined threshold.

Certain embodiments of the present invention also provide a system that includes a power source, such as a standard wall outlet, a switching apparatus connected to the power source, a first deicer connected to the power source through the switching apparatus, and a second deicer connected to the power source through the switching apparatus.

The switching apparatus may include a plug electrically connected to the power source, a first outlet selectively connected to the plug through a first circuit, such that the first deicer is connected to the switching apparatus through the first outlet, a first sensor connected to the first outlet, a first switch disposed within the first circuit, a second outlet selectively connected to the plug through a second circuit, such that the second deicer is connected to the switching apparatus through the second outlet, a second sensor connected to the second outlet, a second switch disposed within the second circuit, and a processing unit in electrical communication with the first and second switches and the first and second sensors. The processing unit may be configured to selectively open and close the first and second switches based on parameters sensed by the first and second sensors.

Certain embodiments of the present invention also provide a method of selectively supplying power to first and second deicers connected to a power source through a switching apparatus. The switching apparatus connects to the power source through a plug, and the first and second deicers are positioned within first and second water receptacles, respectively. The method includes sensing a parametric change, selectively completing and breaking a first electrical circuit between the plug and the first deicer based on the sensing step, and selectively completing and breaking a second electrical circuit between the plug and the second deicer based on the sensing step.

The second electrical circuit is broken when the first electrical circuit is completed, and the first electrical circuit is broken when the second electrical circuit is completed. The parametric change may be a change of current in at least one of the first and second electrical circuits. Optionally, the parametric change may be a change in resistance in at least one of the first and second circuits.

### BRIEF DESCRIPTION OF SEVERAL VIEWS OF THE DRAWINGS

FIG. 1 illustrates a simplified top plan view of multiple electrical devices connected to a single source of electrical power according to an embodiment of the present invention.

FIG. 2 illustrates a schematic diagram of a switching apparatus according to an embodiment of the present invention.

FIG. 3 illustrates a flow chart of a method of supplying electrical power to multiple electrical devices according to an embodiment of the present invention.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

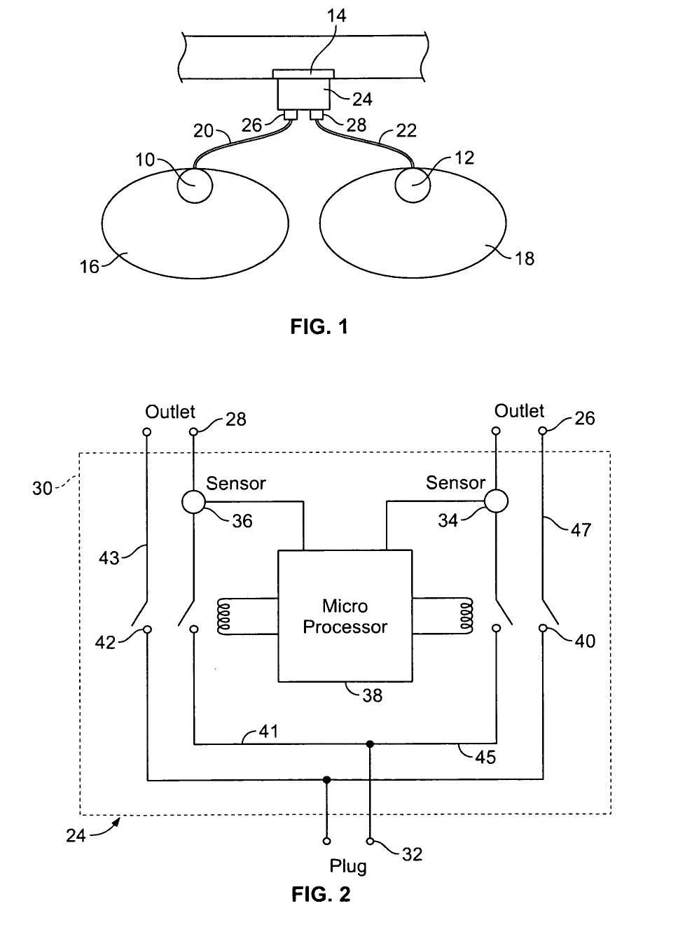

FIG. 1 illustrates a simplified top plan view of multiple electrical devices 10 and 12 connected to a single source 14 of electrical power according to an embodiment of the present invention. The electrical devices 10 and 12 may be deicers positioned within water receptacles 16 and 18, respectively. The electrical source 14 may be a standard 120 volt electrical outlet. The water receptacles 16 and 18 may be, for example, livestock water troughs or birdbaths.

Each electrical device 10 and 12 may be electrically connected to the source 14 through electrical cords 20 and 22, respectively. The cords 20 and 22 electrically connect to the source 14 through a switching apparatus 24 that plugs into the electrical source 14. The switching apparatus 24 also includes multiple outlets 26 and 28. The cord 20 plugs into the outlet 26, while the cord 22 plugs into the outlet 28. While FIG. 1 shows a switching apparatus 24 having two outlets 26 and 28, the apparatus 24 may include more outlets than those shown to accommodate additional electrical devices.

FIG. 2 illustrates a schematic diagram of the switching apparatus 24 according to an embodiment of the present invention. The switching apparatus 24 includes a main housing 30 that may be formed of insulated plastic or the like. One side of the apparatus 24 includes an electrical plug 32 that is configured to plug into the electrical source 14 (shown in FIG. 1), which may be a standard electrical outlet. The opposite side of the apparatus 24 includes the outlets 26 and 28, which are configured to receive plugs of the cords 20 and 22 (shown in FIG. 1). Additional outlets may be positioned at various points within the apparatus 24.

The outlets 26 and 28 are electrically connected to sensors 34 and 36, respectively. The sensors 34 and 36 are connected to wires 47 and 43, which are, in turn, connected to the outlets 26 and 28, respectively. The sensors 34 and 36 are also electrically connected to a processing unit 38, such as a microprocessor, or various other types of processors. Switches 40 and 42 are disposed between the plug 32 and each outlet 26 and 28, respectively. Switch 40 is disposed between wires 45 (connected to the plug 32) and 47 (connected to the outlet 26), while switch 42 is disposed between wires 41 (connected to the plug 32) and 43 (connected to the outlet 28).

Referring to FIGS. 1 and 2, in operation, the processing unit 38 is configured to determine when one of the electrical devices 10 and 12 attempts to draw current from the electrical source 14. The processing unit 38 may, for example, monitor the current in the wires leading to each outlet 26 and 28 through the sensors 40 and 42. Optionally, the processing unit 38 may monitor the resistance of the devices 10 and 12 and determine when the resistance drops from infinity, thereby indicating the devices 10 and 12 have been activated. When one device 10 or 12 attempts to draw current from the power source 14, the processing unit 38 enables an electrical path (i.e., completes a circuit) from the power source 14 to that device 10 or 12, while it disables the electrical path (i.e., “breaks” connection within a circuit) from the power source 14 to the other device 10 or 12, as discussed below.

Power to each of the outlets 26 and 28 is switched on or off by the apparatus 24 through the processing unit 38. The processing unit 38 determines when one of the devices 10 or 12 activates, and then acts to deactivate the other device 10 or 12. For example, when the device 10 attempts to draw current from the power source 14 (i.e., when the device 10 is to be activated), the processing unit 38 sends a signal to move the switch 42 into the off position, and sends a signal to move the switch 40 into the on position. Thus, an electrical path is formed between the electrical source 14, the plug 32, wires 41, the switch 42, the wires 43, and the outlet 28. At the same time, the electrical path that previously existed between the plug 32, wires 45, the switch 40, the wires 47, and the outlet 26 is broken due to the switch 40 being moved into the off position. As such, power is cut off from the outlet 28, and therefore the device 12, while power is supplied to the outlet 26, and therefore, the device 10.

Power to the device 12 remains cut off until the device 10 is deactivated (such as when the water in the receptacle 16 reaches a certain heated temperature). When the processing unit 38 senses that the device 10 is no longer drawing power, the processing unit 38 moves the switch 42 into the on position, and moves the switch 40 into the off position, such that power is supplied to the outlet 28, and therefore the device 12, while power is cut off from the outlet 26, and therefore the device 10. The cycle repeats itself as the devices 10 and 12 are deactivated (such as by heating the water within the receptacles 16 and 18 to certain heated temperatures). That is, as one device 10 or 12 deactivates, the processing unit 38 acts to cut off the power supply to that device 10 or 12, and switch on the power supply to the other of the devices 10 or 12. Optionally, when one of the devices 10 or 12 deactivates, the processing unit 38 may be configured to enable an electrical path to the next device 10 or 12 that attempts to draw current from the electrical source 14.

Also, alternatively, the apparatus 24 may be configured to automatically cut off power to a device 10 or 12 after a set period of time. For example, the processing unit 38 may be configured to allow the device 10 to draw current for a first predetermined time period. After the first predetermined time period, the apparatus 24 cuts off power to the device 10 and provides power to the device 12 for a second predetermined time period, which may be the same as the first predetermined time period. After the second predetermined time period, the apparatus 24 switches so that power is supplied to the device 10 and cut off from the device 12. The cycle may then repeat. As such, the apparatus 24 may force the devices 10 and 12 to share the available power.

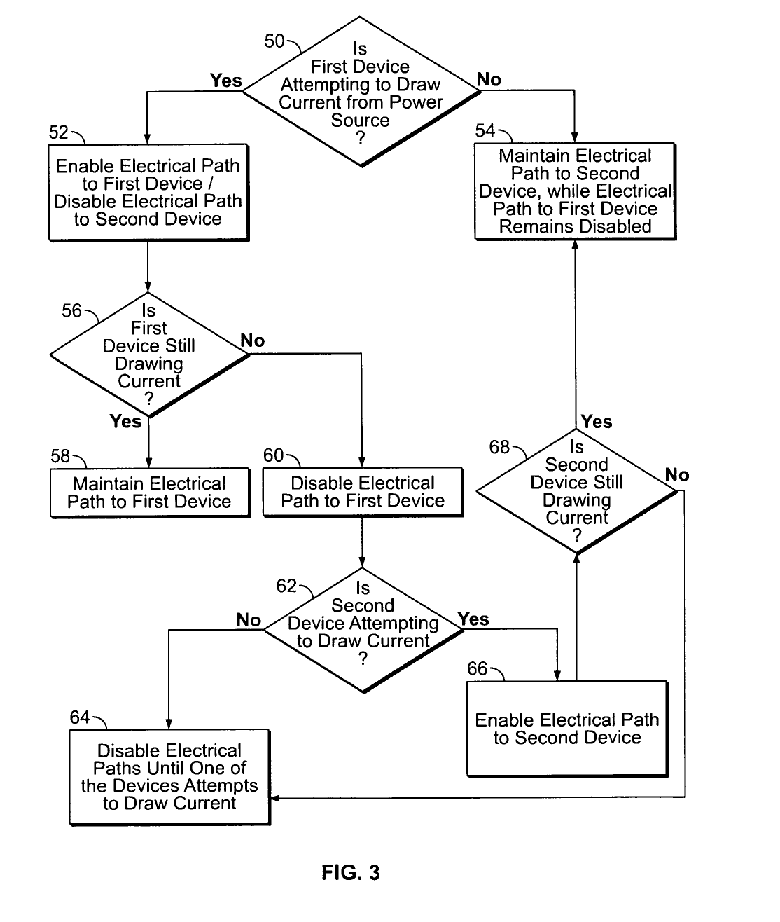

FIG. 3 illustrates a flow chart of a method of supplying electrical power to multiple electrical devices according to an embodiment of the present invention. At 50, the processing unit determines whether a first electrical device is attempting to draw current from a power source. If the first device is attempting to draw current, the processing unit enables an electrical path (i.e., completes a circuit) to the first device and disables an electrical path (i.e., breaks a circuit), if not already disabled, to the second device at 52. If the first device is not attempting to draw current, the processing unit acts to maintain the electrical path to the second device (if the second device is drawing current), while the electrical path to the first device remains disabled at 54.

At 56, if the first device is still drawing current, the electrical path to the first device is maintained at 58. If, however, the first device is no longer drawing current, the electrical path to the first device is disabled at 60.

At 62, the processing unit then determines if the second device is attempting to draw current. If the second device is not attempting to draw current, the electrical paths to both devices are disabled until one of the devices attempts to draw current at 64. Optionally, the electrical path to the first device may be enabled.

If, however, the second device is attempting to draw current, the processing unit enables the electrical path to the second device at 66. At 68, the processing unit then determines if the second device is still drawing current. If it is, the electrical path to the second device is maintained, while the electrical path to the first device remains disabled at 54. If, however, the processing unit determines that the second device is no longer drawing current, then the electrical path is disabled at 64.

Referring to FIGS. 1-3, if the devices 10 and 12 are deicers, the apparatus 24 may be configured so that the devices 10 and 12 take turns drawing power from the source 14. Because a high powered deicer typically operates at less than 50% duty cycle, the two water receptacles 16 and 18 may be kept ice free using one 15 amp circuit even though the two devices 10 and 12 would previously have used two separate circuits. Even on very cold days, when the devices 10 and 12 would normally operate at much higher duty cycles, the devices 10 and 12 can still effectively heat the water within the respective water receptacles 16 and 18. For example, a first deicer may heat water within a first tank, thereby providing drinking water for livestock, while the second tank freezes over. After a set amount of time, the switching apparatus 24 switches power to the second deicer, so that the water within the frozen tank melts, while water within the first tank freezes. The process continues with each deicer being activated and deactivated after set periods of time.

In situations where both devices 10 and 12 attempt to turn on at the same time, the processing unit 38 may sense that the devices 10 and 12 are attempting to activate before power is actually supplied to either device 10 and 12. At this point, the processing unit 38 may simply choose which device 10 or 12 to activate based upon a predetermined algorithm. Alternatively, a reduced amount of current may be supplied to each device 10 and 12 until the processing unit 38 determines which device 10 or 12 to fully activate.

Additionally, the apparatus 24 may be configured so that neither device 10 or 12 receives power when the sensed temperature exceeds a certain threshold. For example, the apparatus 24 may include a thermometer (in electrical communication with the processing unit 38) configured to measure outside air temperature. If the outside temperature exceeds the freezing point, the electrical paths to each device 10 or 12 may be disabled.

Thus, embodiments of the present invention provide a system and method of efficiently delivering electrical power to multiple electrical devices that are intermittently activated.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims.

1. An apparatus configured to selectively supply power among a plurality of electrical devices, the apparatus comprising:
a plug configured to be electrically connected to a power source;
a first outlet selectively connected to said plug;
a first sensor connected to said first outlet;
a first switch disposed between said first outlet and said plug;
a second outlet selectively connected to said plug;
a second sensor connected to said second outlet;
a second switch disposed between said second outlet and said plug; and
a processing unit in electrical communication with said first and second switches and said first and second sensors, said processing unit configured to selectively open and close said first and second switches based on parameters sensed by said first and second sensors.

2. The apparatus of claim 1, wherein said processing unit is configured to close one of said first and second switches to complete one of a first circuit and a second circuit, respectively, based on whether a device attempts to draw current through one of said first and second outlets.

3. The apparatus of claim 1, wherein said processing unit is configured to close one of said first and second switches to complete one of a first circuit and a second circuit, respectively, based on a sensed change of resistance at one of said first and second outlets.

4. The apparatus of claim 2, wherein said processing unit is configured to close said first switch to complete a first circuit when said processing unit determines that a first device is attempting to draw current through said first outlet.

5. The apparatus of claim 4, wherein said processing unit is further configured to open said second switch to break a second circuit when said processing unit determines that the first device is attempting to draw current through said first outlet.

6. The apparatus of claim 4, wherein said processing unit is further configured to open said first switch to break the first circuit when said processing unit determines that the first device is no longer attempting to draw current through said first outlet.

7. The apparatus of claim 1, further comprising a thermometer in electrical communication with said processing unit, wherein said processing unit opens both said first and second switches to break first and second circuits when said thermometer detects a temperature above a predetermined threshold.

8. A system comprising:
a power source;
a switching apparatus connected to said power source;
a first deicer connected to said power source through said switching apparatus; and
a second deicer connected to said power source through said switching apparatus,
said switching apparatus comprising:
a plug electrically connected to said power source;
a first outlet selectively connected to said plug through a first circuit, said first deicer being connected to said switching apparatus through said first outlet;
a first sensor connected to said first outlet;
a first switch disposed within said first circuit;
a second outlet selectively connected to said plug through a second circuit, said second deicer being connected to said switching apparatus through said second outlet;
a second sensor connected to said second outlet;
a second switch disposed within said second circuit; and
a processing unit in electrical communication with said first and second switches and said first and second sensors, said processing unit configured to selectively open and close said first and second switches based on parameters sensed by said first and second sensors.

9. The system of claim 8, wherein said processing unit is configured to close one of said first and second switches to complete one of said first and second circuits, respectively, based on whether one of said first and second deicers attempts to draw current through one of said first and second outlets.

10. The system of claim 8, wherein said processing unit is configured to close one of said first and second switches to complete one of said first and second circuits, respectively, based on a sensed change of resistance at one of said first and second outlets.

11. The system of claim 9, wherein said processing unit is configured to close said first switch to complete a first circuit when said processing unit determines that said first deicer is attempting to draw current through said first outlet.

12. The system of claim 11, wherein said processing unit is further configured to open said second switch to simultaneously break said second circuit.

13. The system of claim 9, wherein said processing unit is further configured to open said first switch to break said first circuit when said processing unit determines that said first deicer is no longer attempting to draw current through said first outlet.

14. The system of claim 8, further comprising a thermometer in electrical communication with said processing unit, wherein said processing unit opens both said first and second switches to break said first and second circuits when said thermometer detects a temperature above a predetermined threshold.

15. A method of selectively supplying power to first and second deicers connected to a power source through a switching apparatus, wherein the switching apparatus connects to the power source through a plug, and wherein the first and second deicers are positioned within first and second water receptacles, respectively, the method comprising:
sensing a parametric change;
selectively completing and breaking a first electrical circuit between the plug and the first deicer based on said sensing; and
selectively completing and breaking a second electrical circuit between the plug and the second deicer based on said sensing.

16. The method of claim 15, wherein the second electrical circuit is broken when the first electrical circuit is completed, and wherein the first electrical circuit is broken when the second electrical circuit is completed.

17. The method of claim 15, wherein said sensing a parametric change comprises sensing a change of current in at least one of the first and second electrical circuits.

18. The method of claim 15, wherein said sensing a parametric change comprises sensing a change of resistance in at least one of the first and second electrical circuits.

19. The method of claim 15, wherein said sensing a parametric change comprises sensing that the first deicer is attempting to draw current, and wherein the first circuit is completed when the first deicer attempts to draw current.

20. The method of claim 19, further comprising simultaneously breaking the second circuit.
